(19) United States
(12) Patent Application Publication
(10) Pub. No.: US 2004/0002889 A1
(43) Pub. Date: Jan. 1, 2004

(54) Customer-interactive virtual modeling system

(76) Inventor: Kumar Singarajan, Canton, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 10/183,241

(22) Filed: Jun. 26, 2002

(51) Int. Cl. G06F 17/60

(52) U.S. Cl. 705/10

(57) ABSTRACT

An interactive consumer preference based product development system wherein a design feature is translated into a logical functional model language that is downloaded into consumer marketing platforms. Consumer preference data is gathered from the marketing platforms and used to quantify consumer preferences and drive product specifications.

### FIELD OF THE INVENTION

The present invention relates generally to an interactive marketing system and in particular, to a virtual modeling system that aids in new product development by interacting with the consumer to generate product preference data.

### BACKGROUND OF THE INVENTION

Each year companies dedicate an enormous amount of their operating budget to new product development. This is particularly true in the highly competitive and fast-paced automotive industry. The challenge is to anticipate what features the consumer will consider desirable and implement these features on upcoming models.

Currently, automakers hold consumer response clinics to gather consumer preference data on prospective features for new model automobiles. Consumers are asked to evaluate product concepts while market researchers and engineers monitor the consumer reactions and document them for later review. The information gathered from the clinical observations is later used to gauge consumer demand and make feature selections for new model years. The effectiveness of the clinics is limited and the data collected is subjective. Three observers may view the same reaction yet interpret the meaning of that reaction very differently. Comments that the consumer makes while being observed are often misconstrued and debated among the observers. The clinics provide no objective measure of true consumer preference. They are merely interpretations from one observer's point of view. This disparity leads to inaccurate consumer preference data and a less than effective way of measuring consumer preferences.

In lieu of any clinical data, the decision to implement new product ideas is often made ad hoc by executives and other department personnel. There is no known process or procedure for these decisions other than experience and expertise.

What is needed, therefore, is an objective interactive product development modeling and analysis system for gathering, processing and applying consumer preference data. An interactive system that objectively gauges consumer preference data would be advantageous.

### SUMMARY OF THE INVENTION

The present invention is directed toward a virtual modeling system that incorporates consumer preference data into the process of selecting new design features for automobiles and other consumer demand based markets.

The system, according to the present invention, translates specific product features into a logical functional model that may be used for marketing, product planning, engineering, manufacturing and service. Logical functional language ties together the entire process of developing and implementing new product features with one common functional language.

The logical functional models are transferred into suitable marketing platforms based on the feature and the marketing target. For example, in an automotive setting, if the potential feature is a new virtual radio, a suitable marketing platform may be a simulated race car arcade game. Here, the consumer can assemble their racing vehicle based on their own preference of the virtual radio. The marketing platform may represent the majority of a targeted age group, geography or other sales criteria. The consumer preferences are tracked in the form of usage data that is then synthesized and gathered for a manufacturing viability evaluation. The resulting data is an objective measure of consumer preference which is then used to make an informed, reliable design selection. The logical functional model for a particular selected feature then undergoes engineering and product manufacturing synthesis where the feature is incorporated into the end product. The logical functional model may also be used when creating and updating manufacturing, service, and user manuals.

Although the examples set forth above, and in more detail below, are directly related to the automotive industry, the present invention is applicable to any product or process where consumer demand plays a role in business plan objectives.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of an interactive virtual modeling system in accordance with the present invention;

FIG. 2 is a block diagram depicting the virtual functional marketing system in accordance with the present invention.

### DETAILED DESCRIPTION OF THE PREFERRED EMBODIMENTS

The following description of the preferred embodiments is merely exemplary in nature and is in no way intended to limit the invention, its application, or uses.

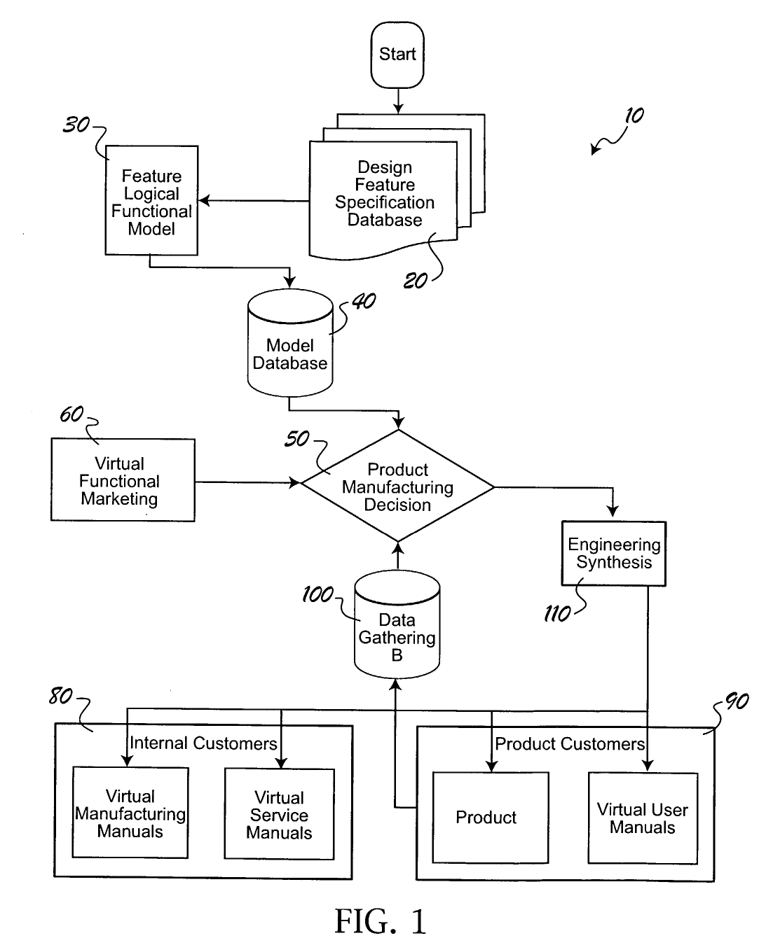

Referring to FIG. 1, the customer interactive virtual modeling system 10, according to the present invention, has a design feature database 20 that stores specification data for design features. In connection with the automobile industry a feature may include a particular body style, a lighting feature, or a console design. The feature possibilities are endless and constantly vary. Although the discussion herein is limited to the automobile industry, the concept of features is applicable to any industry that focuses product research and development on consumer demand.

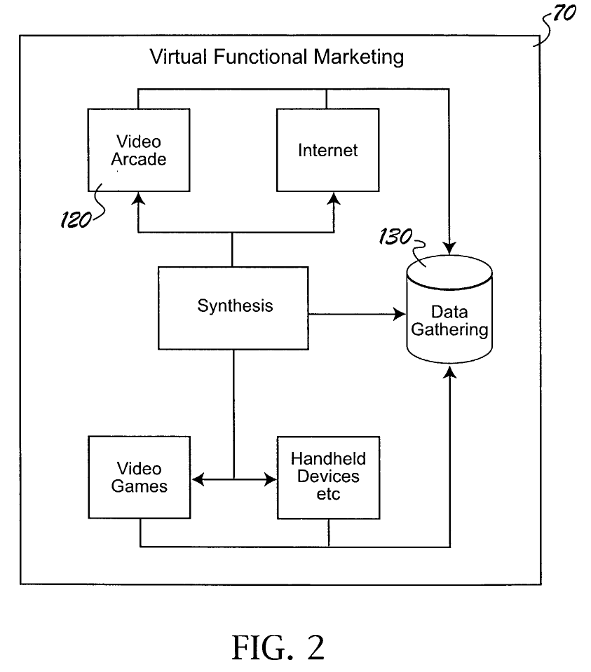

Each feature specification is converted into a logical functional model 30 that parses the feature characteristics into transferable, metric data that is stored in a model database 40. The model database 40 provides feature specification data to the product manufacturing decision 50 either directly or via virtual functional marketing 60 and data gathering 70 (shown in FIG. 2). Post production feedback data from internal customers 80 and product customers 90 is collected via data gathering B 100 and may be used in the product manufacturing decision process 50 to implement a new feature into a product. After an affirmative decision has been made to implement a new product feature, the functional logical model data is used in engineering synthesis 110.

FIG. 2 represents a block diagram of a virtual functional marketing system 70. Virtual marketing 70 takes many forms. The logical functional model language that is transported to various marketing platforms is universal and compatible with any electronic communication system. Data, in the form of a logical functional model, is downloaded into a marketing platform such as a video arcade 120. Consumers play the arcade game 120 as usual; however, their selections and responses are recorded and synthesized. This recording method quantifies the consumer's preference in a measurable manner. Once the information is collected in the data gathering module 130, the responses can be evaluated. Specific features can be downloaded into different platforms for market comparison research. For example, different age groups or different geographic regions can be tested to identify the consumer preferences for each.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An interactive, consumer preference-based method of product development comprising:
generating common logical functional models for specific design features;
compiling logical functional models into a model database;
transferring logical functional models into a consumer marketing platform wherein the consumer selects from an array of design features;
synthesizing consumer preference data collected from the consumer's design feature selections;
gathering synthesized data for viability evaluation;
selecting new design features based on collected consumer preference data.

2. The method of claim 1, further comprising performing engineering synthesis using logical functional models to generate data necessary for manufacturing.

3. The method of claim 2, further comprising incorporating logical functional models for selected design features into product and service manuals.

4. The method of claim 1, wherein said consumer marketing platform is an arcade game.

5. The method of claim 1, wherein said consumer marketing platform resides on the internet.

6. The method of claim 1, wherein said consumer marketing platform is a video game.

7. The method of claim 1, wherein said consumer marketing platform is a handheld electronic device.

8. An interactive, consumer preference based product development system comprising:
a design feature specification database;
a conversion module for translating said design features into a logical functional model;
a logical functional model database;
a consumer marketing platform providing interface between a consumer and said design feature;
a synthesizing module to interpret consumer selection data;
a compilation module for gathering consumer selection data whereby the data is in the form of a logical functional model;
an analysis system for selecting product design features wherein the analysis is founded on the gathered consumer preference data.

9. The system of claim 8, further comprising an engineering synthesis system for applying logical functional models to a manufacturing process.

10. The system of claim 9, further comprising an application module for translating logical functional models into service and product related manuals.
